(19) United States
(12) Patent Application Publication
(10) Pub. No.: US 2013/0080161 A1
(43) Pub. Date: Mar. 28, 2013

(54) SPEECH RECOGNITION APPARATUS AND METHOD

(71) Applicants: Kenji IWATA, Machida-shi (JP); Kentaro TORRI, Yokohama-shi (JP); Naoshi UCHIHIRA, Kawasaki-shi (JP); Tetsuro CHINO, Kawasaki-shi (JP)

(72) Inventors: Kenji IWATA, Machida-shi (JP); Kentaro TORRI, Yokohama-shi (JP); Naoshi UCHIHIRA, Kawasaki-shi (JP); Tetsuro CHINO, Kawasaki-shi (JP)

(73) Assignee: KABUSHIKI KAISHA TOSHIBA, Tokyo (JP)

(21) Appl. No.: 13/628,818

(22) Filed: Sep. 27, 2012

(30) Foreign Application Priority Data
Sep. 27, 2011 (JP) 2011-211469

(51) Int. Cl. G10L 15/00

(52) U.S. Cl. 704/231; 704/E15.001

(57) ABSTRACT

According to one embodiment, a speech recognition apparatus includes following units. The service estimation unit estimates a service being performed by a user, by using non-speech information, and to generate service information. The speech recognition unit performs speech recognition on speech information in accordance with a speech recognition technique corresponding to the service information. The feature quantity extraction unit extracts a feature quantity related to the service of the user, from the speech recognition result. The service estimation unit re-estimates the service by using the feature quantity. The speech recognition unit performs speech recognition based on the re-estimation result.

### CROSS-REFERENCE TO RELATED APPLICATIONS

This application is based upon and claims the benefit of priority from Japanese Patent Application No. 2011-211469, filed Sep. 27, 2011, the entire contents of which are incorporated herein by reference.

### FIELD

Embodiments described herein relate generally to a speech recognition apparatus and method.

### BACKGROUND

Speech recognition apparatuses perform speech recognition on input speech information to generate text data corresponding to the speech information as the result of the speech recognition. The speech recognition accuracy of the speech recognition apparatuses has recently been improved, but the result of speech recognition involves not a few errors. To ensure sufficient speech recognition accuracy if a user utilizes a speech recognition apparatus for the user's various services involving different contents of speech, it is effective to perform speech recognition in accordance with a speech recognition technique corresponding to the content of a service being performed by the user.

Some conventional speech recognition apparatuses perform speech recognition by estimating a country or district based on location information acquired utilizing the Global Positioning System (GPS) and referencing language data corresponding to the estimated country or district. When the speech recognition apparatus estimates the service being performed by the user based only on location information, if for example, the service is instantaneously switched, the apparatus may fail to correctly estimate the service being performed by the user, and disadvantageously provide insufficient speech recognition accuracy. Other speech recognition apparatuses estimate the user's country based on speech information and present information in the language of the estimated country. When the speech recognition apparatus estimates the service being performed by the user based only on speech information, useful information for estimation of the service is not obtained unless speech information is input to the apparatus. Thus, disadvantageously, the apparatus may fail to estimate the service in detail and thus provide insufficient speech recognition accuracy.

As described above, if the user utilizes a speech recognition apparatus for the user's various services with different contents of speech, the speech recognition accuracy can be improved by performing speech recognition in accordance with the speech recognition technique corresponding to the content of the service being performed by the user.

### BRIEF DESCRIPTION OF THE DRAWINGS

FIG. 1 is a block diagram schematically showing a speech recognition apparatus according to a first embodiment;

FIG. 2 is a block diagram schematically showing a mobile terminal with the speech recognition apparatus shown in FIG. 1;

FIG. 3 is a schematic diagram showing an example of a schedule of hospital service;

FIG. 4 is a flowchart schematically showing the operation of the speech recognition apparatus shown in FIG. 1;

FIG. 5 is a flowchart schematically illustrating the operation of an speech recognition apparatus according to Comparative Example 1;

FIG. 6 is a diagram illustrating an example of the operation of the speech recognition apparatus shown in FIG. 1;

FIG. 7 is a diagram illustrating another example of the operation of the speech recognition apparatus shown in FIG. 1;

FIG. 8 is a flowchart schematically illustrating the operation of an speech recognition apparatus according to Comparative Example 2;

FIG. 9 is a diagram illustrating yet another example of the operation of the speech recognition apparatus shown in FIG. 1;

FIG. 10 is a block diagram schematically showing a speech recognition apparatus according to Modification 1 of the first embodiment;

FIG. 11 is a flowchart schematically showing the operation of the speech recognition apparatus shown in FIG. 10;

FIG. 12 is a block diagram schematically showing a speech recognition apparatus according to Modification 2 of the first embodiment;

FIG. 13 is a flowchart schematically showing the operation of the speech recognition apparatus shown in FIG. 12;

FIG. 14 is a block diagram schematically showing a speech recognition apparatus according to Modification 3 of the first embodiment;

FIG. 15 is a flowchart schematically showing the operation of the speech recognition apparatus shown in FIG. 14;

FIG. 16 is a block diagram schematically showing a speech recognition apparatus according to a second embodiment;

FIG. 17 is a diagram showing an example of the relationship between services and language models according to the second embodiment;

FIG. 18 is a flowchart schematically showing the operation of the speech recognition apparatus shown in FIG. 16;

FIG. 19 is a block diagram schematically showing a speech recognition apparatus according to a third embodiment;

FIG. 20 is a flowchart schematically showing the operation of the speech recognition apparatus shown in FIG. 19;

FIG. 21 is a block diagram schematically showing a speech recognition apparatus according to a fourth embodiment;

FIG. 22 is a flowchart schematically showing the operation of the speech recognition apparatus shown in FIG. 21;

FIG. 23 is a block diagram schematically showing a speech recognition apparatus according to a fifth embodiment; and

FIG. 24 is a flowchart schematically showing the operation of the speech recognition apparatus shown in FIG. 23.

### DETAILED DESCRIPTION

In general, according to one embodiment, a speech recognition apparatus includes a service estimation unit, a first speech recognition unit, and a feature quantity extraction unit. The service estimation unit is configured to estimate a service being performed by a user, by using non-speech information related to a user's service, and to generate service information indicating a content of the estimated service. The first speech recognition unit is configured to perform speech recognition on speech information provided by the user, in accordance with a speech recognition technique corresponding to the service information, and to generate a first speech recognition result. The feature quantity extraction unit is configured to extract at least one feature quantity related to the service being performed by the user, from the first speech recognition result. The service estimation unit re-estimates the service by using the at least one feature quantity. The first speech recognition unit performs speech recognition based on service information resulting from the re-estimation.

The embodiment provides a speech recognition apparatus and a speech recognition method which allow the speech recognition accuracy to be improved.

Speech recognition apparatuses and methods according to embodiments will be described below referring to the drawings as needed. In the embodiments, like reference numbers denote like elements, and duplication of explanation will be avoided.

### First Embodiment

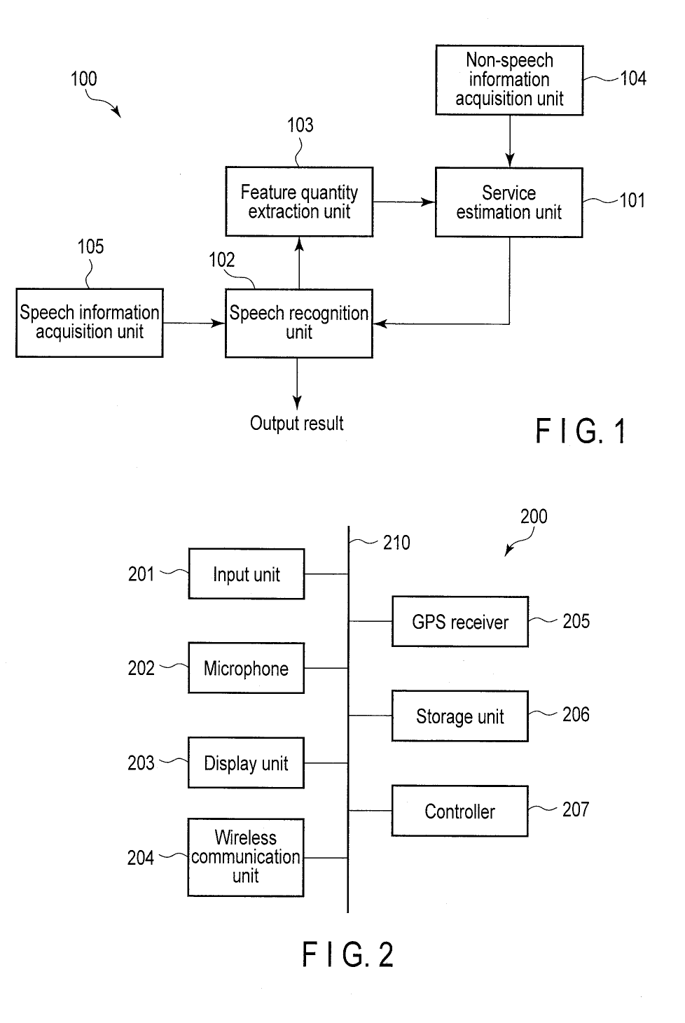

FIG. 1 schematically shows a speech recognition apparatus 100 according to a first embodiment. The speech recognition apparatus 100 performs speech recognition on speech information indicating a speech produced by a user (i.e., a user's speech) and outputs or records text data corresponding to the speech information as the result of the speech recognition. The speech recognition apparatus may be implemented as an independent apparatus or incorporated into another apparatus such as a mobile terminal. In the description of the present embodiment, the speech recognition apparatus 100 is incorporated into a mobile terminal, and the user carries the mobile terminal. Moreover, in specific descriptions, the speech recognition apparatus 100 is used in a hospital by way of example. If the speech recognition apparatus 100 is used in a hospital, the user is, for example, a nurse and performs various services (or operations) such as surgical assistance and tray service. If the user is a nurse, the speech recognition apparatus 100 is utilized, for example, to record nursing of inpatients and to take notes.

First, a mobile terminal with the speech recognition apparatus 100 will be described.

FIG. 2 schematically shows a mobile terminal 200 with the speech recognition apparatus 100. As shown in FIG. 2, the mobile terminal 200 includes an input unit 201, a microphone 202, a display unit 203, a wireless communication unit 204, a Global Positioning System (GPS) receiver 205, a storage unit 206, and a controller 207. The input unit 201, the microphone 202, the display unit 203, the wireless communication unit 204, the GPS receiver 205, the storage unit 206, and the controller 207 are connected together via a bus 210 for communication. The mobile terminal will be simply referred to as a terminal.

The input unit 201 is an input device, for example, operation buttons or a touch panel, and receives instructions from the user. The microphone 202 receives and converts the user's speeches into speech signals. The display unit 203 displays text data and image data under the control of the controller 207.

The wireless communication unit 204 may include a wireless LAN communication unit, a Bluetooth (registered trademark) communication unit, and a contactless communication unit. The wireless LAN communication unit communicates with other apparatuses via surrounding access points. The Bluetooth communication unit performs wireless communication at short range with other apparatuses including a Bluetooth function. The contactless communication unit reads information from radio tags, for example, radio-frequency identification (RFID) tags in a contactless manner. The GPS receiver 205 receives GPS information a GPS satellite to calculate longitude and latitude from the received GPS information.

The storage unit 206 stores various data such as programs that are executed by the controller 207 and data required for various processes. The controller 207 controls the units and devices in the mobile terminal 200. Moreover, the controller 207 can provide various functions by executing the programs stored in the storage unit 206. For example, the controller 207 provides a schedule function. The schedule function includes acceptance of registration of the contents, dates and times, and places of the user's services through the input unit 201 or the wireless communication unit 204 and output of the registered contents. The registered contents (also referred to as schedule information) are stored in the storage unit 206. Furthermore, the controller 207 provides a clock function to notify the user of the time.

The terminal 200 shown in FIG. 2 is an example of the apparatus to which the speech recognition apparatus 100 is applied. The apparatus to which the speech recognition apparatus 100 is applied is not limited to this example. Furthermore, the speech recognition apparatus 100, when implemented as an independent apparatus, may include all or some of the elements shown in FIG. 2.

Now, the speech recognition apparatus 100 shown in FIG. 1 will be described.

The speech recognition apparatus 100 includes a service estimation unit 101, a speech recognition unit 102, a feature quantity extraction unit 103, a non-speech information acquisition unit 104, and a speech information acquisition unit 105.

The non-speech information acquisition unit 104 acquires non-speech information related to the user's services. Examples of the non-speech information include information indicative of the user's location (location information), user information, information about surrounding persons, information about surrounding objects, and information about time (time information). The user information relates to the user and includes information about a job title (for example, a doctor, a nurse, or a pharmacist) and schedule information. The non-speech information is transmitted to the service estimation unit 101.

The speech information acquisition unit 105 acquires speech information indicative of the user's speeches. Specifically, the speech information acquisition unit 105 includes the microphone 202 to acquire speech information from speeches received by the microphone 202. The speech information acquisition unit 105 may receive speech information from an external device, for example, via a communication network. The speech information is transmitted to the speech recognition unit 102.

The speech estimation unit 101 estimates a service being performed by the user, based on at least one of the non-speech information acquired by the non-speech information acquisition unit 104 and a feature quantity (described below) extracted by the feature quantity extraction unit 103. In the present embodiment, services that are likely to be performed by the user are predetermined. The service estimation unit 101 selects one or more of the predetermined services as a service being performed by the user in accordance with a method described below. The service estimation unit 101 generates service information indicative of the estimated service. The service information is transmitted to the speech recognition unit 102.

The speech recognition unit 102 performs speech recognition on speech information from the speech information acquisition unit 105 in accordance with a speech recognition technique corresponding to the service information from the service estimation unit 101. The result of the speech recognition is output to an external device (for example, the storage unit 206) and transmitted to the feature quantity extraction unit 103.

The feature quantity extraction unit 103 extracts a feature quantity for the service being performed by the user from the result of the speech recognition from the speech recognition unit 102. The feature quantity is used to estimate again the service being performed by the user. The feature quantity extraction unit 103 supplies the extracted feature quantity to the service estimation unit 101 to urge the service estimation unit 101 to estimate again the service being performed by the user. The feature quantity extracted by the feature quantity extraction unit 103 will be described below.

The speech recognition apparatus 100 configured as described above estimates the service being performed by the user based on non-speech information, performs speech recognition in accordance with the speech recognition technique corresponding to the service information, and re-estimates the service being performed by the user, by using the information (feature quantity) obtained from the result of the speech recognition. Thus, the service being performed by the user can be correctly estimated. As a result, the speech recognition apparatus 100 can perform speech recognition in accordance with the speech recognition technique corresponding to the service being performed by the user, and thus achieve improved speech recognition accuracy.

Now, the units in the speech recognition apparatus 100 will be described in further detail.

First, the non-speech information acquisition unit 104 will be described. As described above, examples of the non-speech information include location information, user information such as schedule information, information about surrounding persons, information about surrounding objects, and time information. The non-speech information acquisition unit 104 does not necessarily need to acquire all of the illustrated information and may acquire at least one of the illustrated and other types information.

A method in which the non-speech information acquisition unit 104 acquires location information will be specifically described. In one example, the non-speech information acquisition unit 104 acquires latitude and longitude information output by the GPS receiver 205, as location information. In another example, access points for wireless LAN and apparatuses with the Bluetooth function are installed at many locations, and the wireless communication unit 204 detects the access point or apparatus with the Bluetooth function which is closest to the terminal 200, based on received signal strength indication (RSSI). The non-speech information acquisition unit 104 acquires the place where the detected access point or apparatus with the Bluetooth function, as location information.

In yet another example, the non-speech information acquisition unit 104 can acquire location information utilizing RFIDs. In this case, RFID tags with location information stored therein are attached to instruments and entrances of rooms, and the contactless communication unit reads the location information from the RFID tag. In still another example, when the user performs an action enabling the user's location to be determined, such as an action of logging into a personal computer (PC) installed in a particular place, the external device notifies the non-speech information acquisition unit 104 of the location information.

Furthermore, information about surrounding persons and information about surrounding objects can be acquired utilizing the Bluetooth function, RFID, or the like. Schedule information and time information can be acquired utilizing a schedule function and a clock function of the terminal 200.

The above-described method for acquiring non-speech information is illustrative. The non-speech information acquisition unit 104 may use any other method to acquire non-speech information. Moreover, the non-speech information may be acquired by the terminal 200 or may be acquired by the external device, which then communicates the non-speech information to the terminal 200.

Now, a method in which the speech information acquisition unit 105 acquires speech information will be specifically described.

As described above, the speech information acquisition unit 105 includes the microphone 202. In one example, while a predetermined operation button in the input unit 201 is being depressed, the user's speech received by the microphone 202 is acquired as speech information. In another example, the user depresses a predetermined operation button to give an instruction to start input, and the speech information acquisition unit 105 detects silence to recognize the end of the input. The speech information acquisition unit 105 acquires the user's speeches received by the microphone 202 between the beginning and end of the input, as speech information.

Now, a method in which the service estimation unit 101 estimates the user's service will be specifically described.

The service estimation unit 101 can estimate the user's service utilizing a method based on statistical processing. In the method based on statistical processing, for example, a model is pre-created which has been learned to determine the type of a service based on a certain type of input information (at least one of non-speech information and the feature quantity). The service is estimated from actually acquired information (at least one of non-speech information and the feature quantity) based on probability calculations using the model. Examples of the model utilized include existing probability models such as a support vector machine (SVM) and a log linear model.

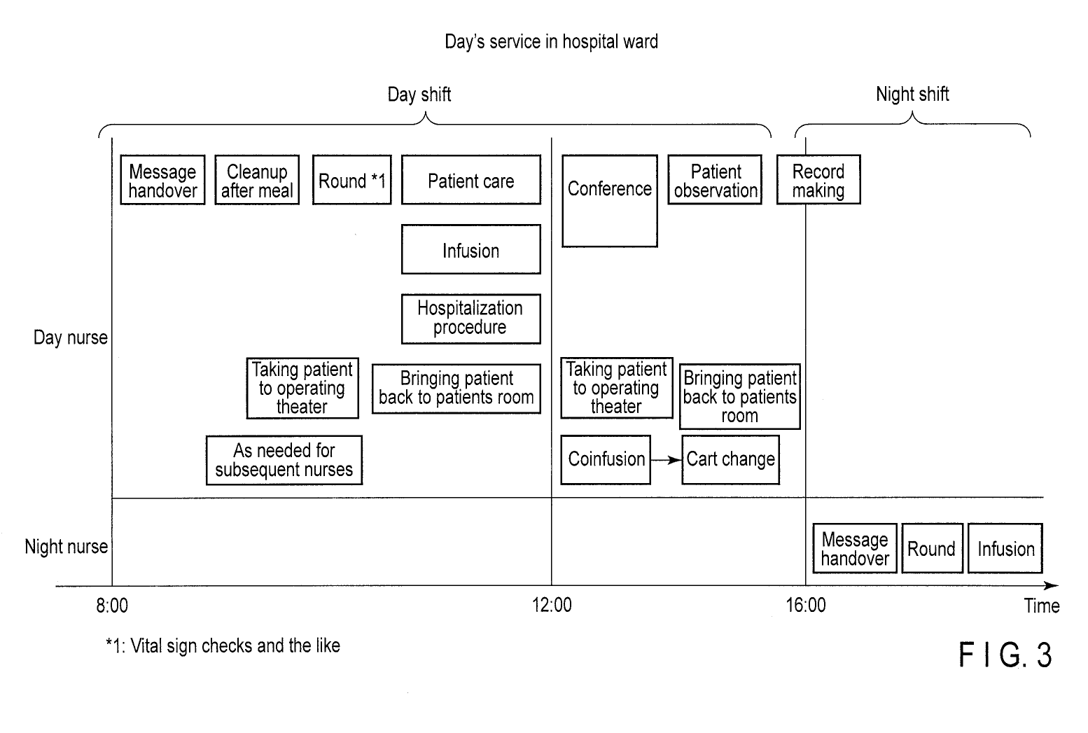

Moreover, the user's schedule may be such that the order in which services are performed is determined to some degree but that the times at which the services are performed are not definitely determined, as in the case of hospital service shown in FIG. 3. In this case, the service estimation unit 101 can estimate the service based on rules using combinations of the schedule information, the location information, and the time information. Alternatively, the probabilities of the services may be predefined for each time slot so that the service estimation unit 101 can acquire the probabilities of the services in association with the time information and corrects the probabilities based on the location information or the speech information to estimate the service being performed by the user, according to the final probability values. For example, the service with the largest probability value or at least one service with a probability value equal to or larger than a threshold is selected as the service being performed by the user. The probability can be calculated utilizing a multivariate logistic regression model, a Bayesian network, a hidden Markov model, or the like.

The service estimation unit 101 is not limited to the example in which the service estimation unit 101 estimates the service being performed by the user in accordance with the above-described method, but may use any other method to estimate the service being performed by the user.

Now, a method in which the speech recognition unit 102 performs speech recognition will be specifically described.

In the present embodiment, the speech recognition unit 102 performs speech recognition in accordance with the speech recognition technique corresponding to the service information. Thus, the result of speech recognition varies depending on the service information. Three exemplary speech recognition methods illustrated below are available.

A first method utilizes an N-best algorithm. Specifically, the first method first performs normal speech recognition to generate a plurality of candidates for the speech recognition result with the confidence scores. Subsequently, the appearance frequencies of words and the like which are predetermined for each service are used to calculate scores indicative of the degree of matching between each of the speech recognition result candidates and the service indicated by the service information. Then, the calculated scores are reflected in the confidence scores of the speech recognition result candidates. This improves the confidence scores of the speech recognition result candidates corresponding to the service information. Finally, the speech recognition result candidate with the highest confidence score is selected as the speech recognition result.

A second method describes associations among words for each service in a language model used for speech recognition, and performs speech recognition using the language model with the associations among the words varied depending on the service information. A third method holds a plurality of language models in association with the respective predetermined services, selects any of the language models which corresponds to the service indicated by the service information, and performs speech recognition using the selected language model. The term “language model” as used herein refers to linguistic information used for speech recognition such as information described in a grammar form or information describing the appearance probabilities of a word or a string of words.

Here, performing speech recognition in accordance with the speech recognition technique corresponding to the service information means performing the speech recognition method (for example, the above-described first method) in accordance with the service information, and not switching among the speech recognition methods (for example, the above-described first, second, and third speech recognition methods) in accordance with the service information for speech recognition.

The speech recognition unit 102 is not limited to the example in which the speech recognition unit 102 performs speech recognition in accordance with one of the above-described three methods, but may use any other method for the speech recognition.

Now, the feature quantity extracted by the feature quantity extraction unit 103 will be described.

If the speech recognition unit 102 performs speech recognition in accordance with the above-described N-best algorithm, the feature quantity related to the service being performed by the user may be the appearance frequencies of words contained in the speech recognition result for the service indicated by the service information. The appearance frequencies of words contained in the speech recognition result for the service indicated by the service information correspond to the frequencies at which the respective words are used in the service indicated by the service information. The frequencies indicate how the speech recognition result matches the service indicated by the service information. In this case, text data collected for each of a plurality of predetermined services is analyzed to pre-create a look-up table that holds a plurality of words in association of appearance frequencies for each service. The feature quantity extraction unit 103 uses the service indicated by the service information and each of the words contained in the speech recognition result to reference the look-up table to obtain the appearance frequency of the word in the service.

Furthermore, if the above-described language model is used for speech recognition, the feature quantity may be the language model likelihood of the speech recognition result or the number of times or the rate of the presence, in the string of words in the speech recognition result, of a sequence of words absent from learning data used to create the language model. Here, the language model likelihood of the speech recognition result is indicative of the linguistic probability of the speech recognition result. More specifically, the language model likelihood of the speech recognition result indicates the likelihood resulting from the language model, which is included in the likelihoods for the speech recognition result obtained by probability calculations for the speech recognition. How the string of words contained in the speech recognition result matches the language model used for the speech recognition is indicated by the language model likelihood of the speech recognition result and the number of times or the rate of the presence, in the string of words in the speech recognition result, of a sequence of words absent from learning data required to create the language model. In this case, the information of the language model used for the speech recognition needs to be transmitted to the feature quantity extraction unit 103.

Moreover, the feature quantity may be the number of times or the rate of the appearance, in the speech recognition result, of a word used only in a particular service. If the speech recognition result includes a word used only in a particular service, the particular service may be determined to be the service being performed by the user. Thus, the service being performed by the user can be correctly estimated by using, as the feature quantity, the number of times or the rate of the appearance, in the speech recognition result, of the word used only in the particular service.

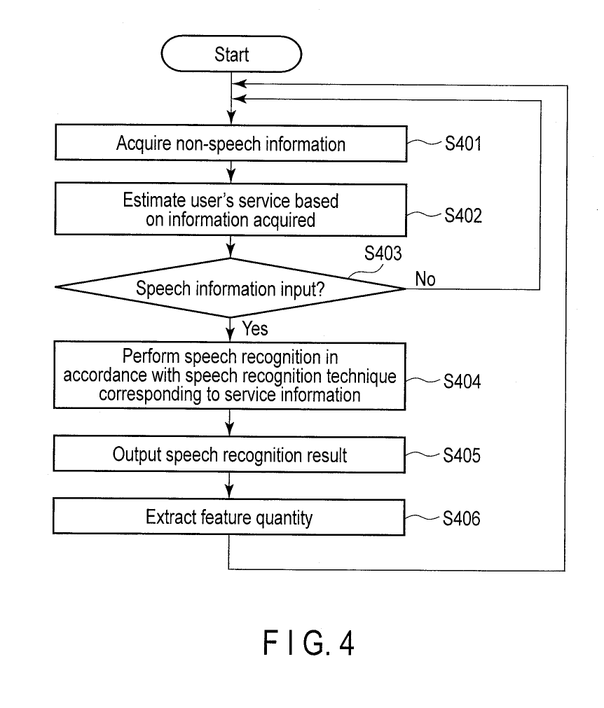

Now, the operation of the speech recognition apparatus 100 will be described with reference to FIG. 1 and FIG. 4.

FIG. 4 shows an example of a speech recognition process that is executed by the speech recognition apparatus 100. First, when the user starts the speech recognition apparatus 100, the non-speech information acquisition unit 104 acquires non-speech information (step S401). The service estimation unit 101 estimates the service being currently performed by the user to generate service information indicative of the content of the service, based on the non-speech information acquired by the non-speech information acquisition unit 104 (step S402).

Then, the speech recognition unit 102 waits for speech information to be input (step S403). When the speech recognition unit 102 receives speech information, the process proceeds to step S404. The speech recognition unit 102 performs speech recognition on the received speech information in accordance with the speech recognition technique corresponding to the service information (step S404).

If no speech information is input in step S403, the process returns to step S401. That is, until speech information is input, the service estimation is repeatedly performed based on the non-speech information acquired by the non-speech information acquisition unit 104. In this case, provided that the service estimation is carried out at least once after the speech recognition apparatus 100 is started, speech information may be input at any timing between step S401 and step S403. That is, the service estimation in step S402 may be carried out at least once before the speech recognition in step S404 is executed.

The process of estimating the service based on the non-speech information acquired by the non-speech information acquisition unit 104 need not be carried out constantly except during speech recognition. The process may be carried out at intervals of a given period or when the non-speech information changes significantly. Alternatively, the speech recognition apparatus 100 may estimate the service when speech information is input and then perform speech recognition on the input speech information.

When the speech recognition in step S404 is completed, the speech recognition unit 102 outputs the result of the speech recognition (step S405). In one example, the speech recognition result is stored in the storage unit 206 and displayed on the display unit 203. Displaying the speech recognition result allows the user to determine whether the speech has been correctly recognized. The storage unit 206 stores the speech recognition result together with another piece of information such as time information.

Then, the feature quantity extraction unit 103 extracts a feature quantity related to the service being performed by the user from the speech recognition result (step S406). The processing in step S405 and the processing in step S406 may be carried out in the reverse order or at the same time. When the feature quantity is extracted in step S406, the process returns to step S401. In step S402 following the speech recognition, the service estimation unit 101 re-estimates the service being performed by the user, by using the non-speech information acquired by the non-speech information acquisition unit 104 and the feature quantity extracted by the feature quantity extraction unit 103.

After the processing in step S406 is carried out, the process may return to step S402 rather than to step S401. In this case, the service estimation unit 101 re-estimates the service by using the feature quantity extracted by the feature quantity extraction unit 103 and not the non-speech information acquired by the non-speech information acquisition unit 104.

As described above, the speech recognition apparatus 100 estimates the service being performed by the user based on the non-speech information acquired by the non-speech information acquisition unit 104, performs speech recognition in accordance with the speech recognition technique corresponding to the service information, and re-estimates the service by using the feature quantity extracted from the speech recognition result. Thus, the service being performed by the user can be correctly estimated by using the non-speech information acquired by the non-speech information acquisition unit 104 and the information (feature quantity) obtained from the speech recognition result. As a result, the speech recognition apparatus 100 can perform speech recognition in accordance with the speech recognition technique corresponding to the service being performed by the user, and thus provides improved speech recognition accuracy.

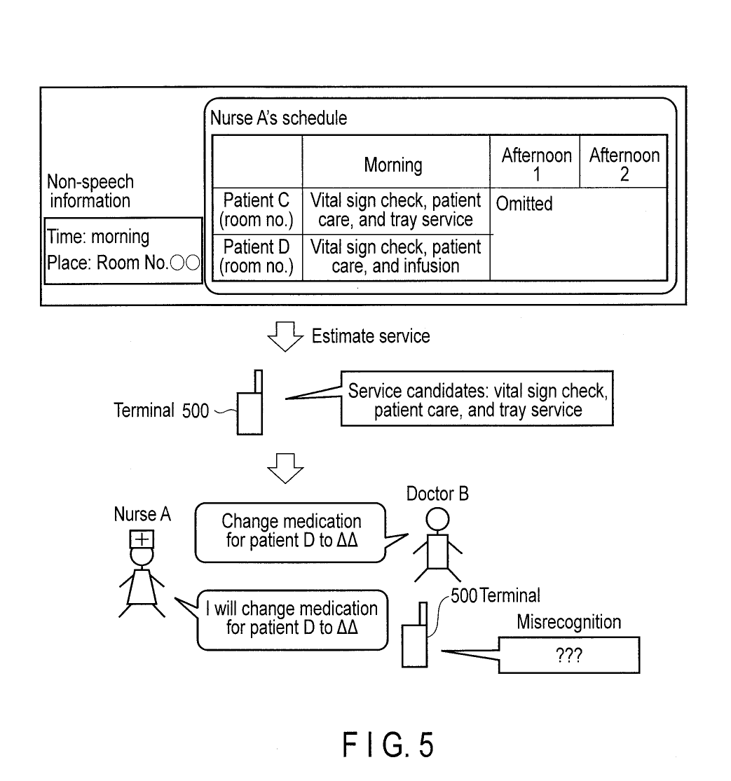

Now, with reference to FIG. 5 to FIG. 9, situations in which the speech recognition apparatus 100 according to the present embodiment is advantageous will be specifically described in comparison with a speech recognition apparatus according to Comparative Example 1 and a speech recognition apparatus according to Comparative Example 2. Here, the speech recognition apparatus according to Comparative Example 1 estimates the service based only on the non-speech information. Furthermore, the speech recognition apparatus according to Comparative Example 2 estimates the service based only on the speech information (or speech recognition result). In cases illustrated in FIG. 5 to FIG. 9, the speech recognition apparatus is a terminal carried by each nurse in a hospital, and internally functions to estimate the service being performed by the nurse. The speech recognition apparatus is used by the nurse to record nursing and to take notes. When the nurse inputs speech, the speech recognition apparatus performs, on the speech, speech recognition specified for the service being currently performed.

FIG. 5 shows an example of operation of the speech recognition apparatus (terminal) 500 according to Comparative Example 1. The case shown in FIG. 5 corresponds to an example in which speech recognition cannot be correctly achieved. As shown in FIG. 5, as non-speech information, a nurse A's schedule information, the nurse A's location information, and time information have been acquired. The service currently being performed by the nurse A has been narrowed down to “vital sign check”, “patient care”, and “tray service” based on non-speech information acquired. That is, the service information includes the “vital sign check”, the “patient care”, and the “tray service”. Here, the “vital sign check” is a service for measuring and recording patients' temperatures and blood pressures. The “patient care” is a service for washing patients' bodies, for example. Moreover, the “tray service” is a service for distributing food among the patients. However, the nurse A does not necessarily perform one of these services. For example, the nurse A may be instructed by a doctor B to change a medication administered to a patient D. Thus, a service called “medication change” and in which the nurse A changes the medication to be administered may occur in an interruptive manner. When such an interruptive service is aurally recorded, since the service information does not include the “medication change”, the speech recognition apparatus 100 is likely to misrecognize the nurse A's speech. To avoid the misrecognition, the service being performed by the user needs to be estimated again. However, the non-speech information such as the location information does not change significantly, and thus the speech recognition apparatus 500 cannot change the service information so that the information includes the “medication change”.

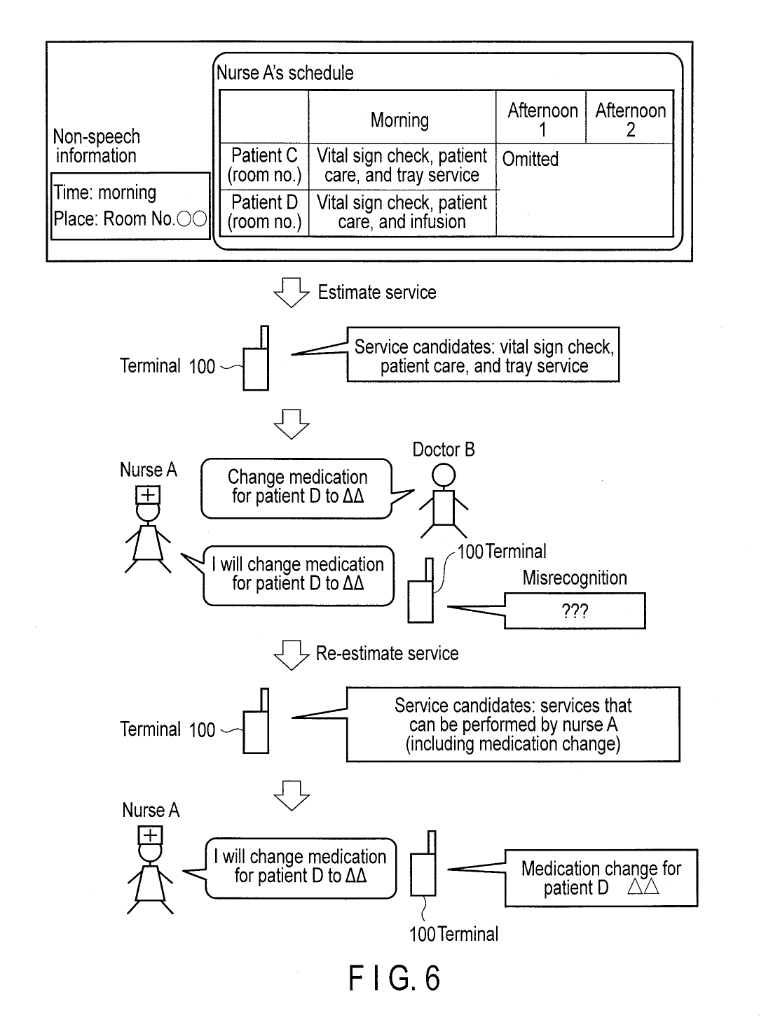

FIG. 6 shows an example of operation of the speech recognition apparatus (terminal) 100 according to the present embodiment. More specifically, FIG. 6 shows an example of operation of the speech recognition apparatus 100 in the same situation as that illustrated in FIG. 5. As in the case illustrated in FIG. 5, the service being currently performed by the nurse A has been narrowed down to the “vital sign check”, the “patient care”, and the “tray service”. At this time, even when the nurse A correctly inputs speech related to the “medication change” service, since the service information does not include the “medication change”, the speech recognition apparatus 100 may fail to correctly recognize the speech as in the case illustrated in FIG. 5. As shown in FIG. 6, in the speech recognition apparatus 100 according to the present embodiment, the speech recognition unit 102 receives speech information related to the “medication change” and performs speech recognition. Then, the feature quantity extraction unit 103 extracts a feature quantity from the result of the speech recognition. The service estimation unit 101 uses the extracted feature quantity to re-estimate the service. The re-estimation results in the service information including all possible services that are performed by the nurse A. For example, the service information includes the “vital sign check”, the “patient care”, the “tray service”, and the “medication change”. In this state, when the nurse A inputs speech information related to the “medication change” again, since the service information includes the “medication change”, the speech recognition apparatus 100 can correctly recognize the speech. Even if the user's service is instantaneously changed as in the case of the example illustrated in FIG. 6, the speech recognition apparatus according to the present embodiment can perform speech recognition according to the user's service.

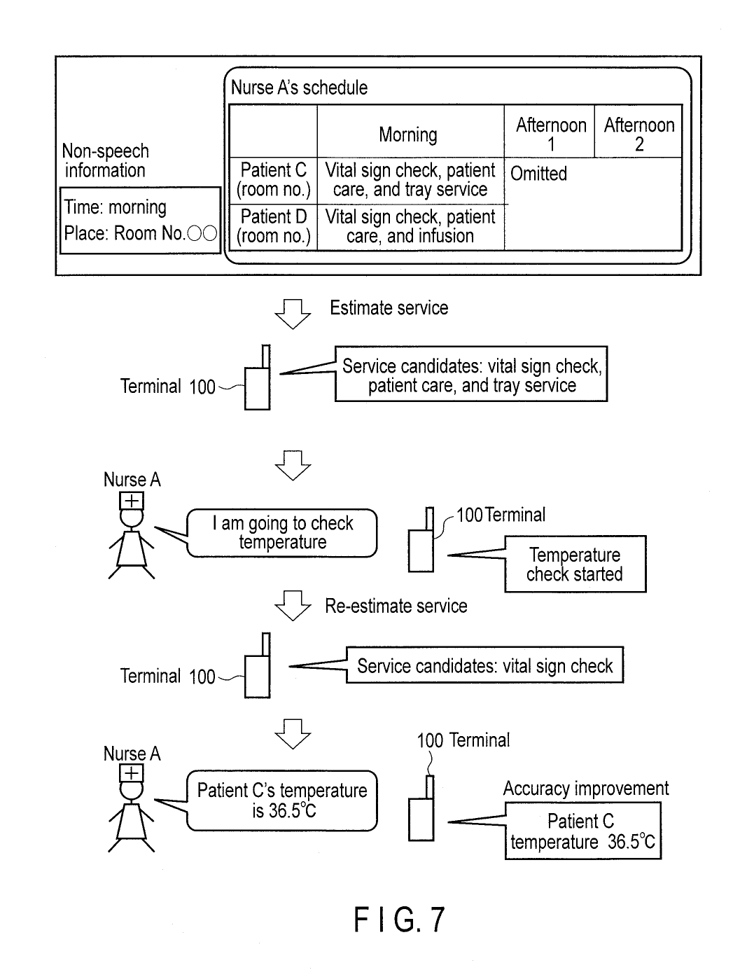

FIG. 7 shows another example of operation of the speech recognition apparatus 100 according to the present embodiment. More specifically, FIG. 7 shows an operation of estimating the service in detail by using a feature quantity obtained from speech information. Also in the case illustrated in FIG. 7, the service being currently performed by the nurse A has been narrowed down to the “vital sign check”, the “patient care”, and the “tray service”, as in the case illustrated in FIG. 5. At this time, it is assumed that the nurse A inputs speech information related to a “vital sign check” service for checking patients' temperatures. The speech recognition apparatus 100 performs speech recognition on the speech information and generates the result of the speech recognition. Moreover, the speech recognition apparatus 100 extracts a feature quantity indicative of the “vital sign check” service from the speech recognition result in order to improve the speech recognition accuracy for the subsequent speeches related to the “vital sign check” service. The speech recognition apparatus 100 then uses the extracted feature quantity to re-estimate the service. Thus, the speech recognition apparatus 100 determines the “vital sign check”, one of the results of the last estimation, the “vital sign check”, the “patient care”, and the “tray service”, to be the service being performed by the nurse A. Subsequently, when the nurse A inputs speech information related to the results of temperature checks, the speech recognition apparatus 100 can correctly recognize the nurse A's speech.

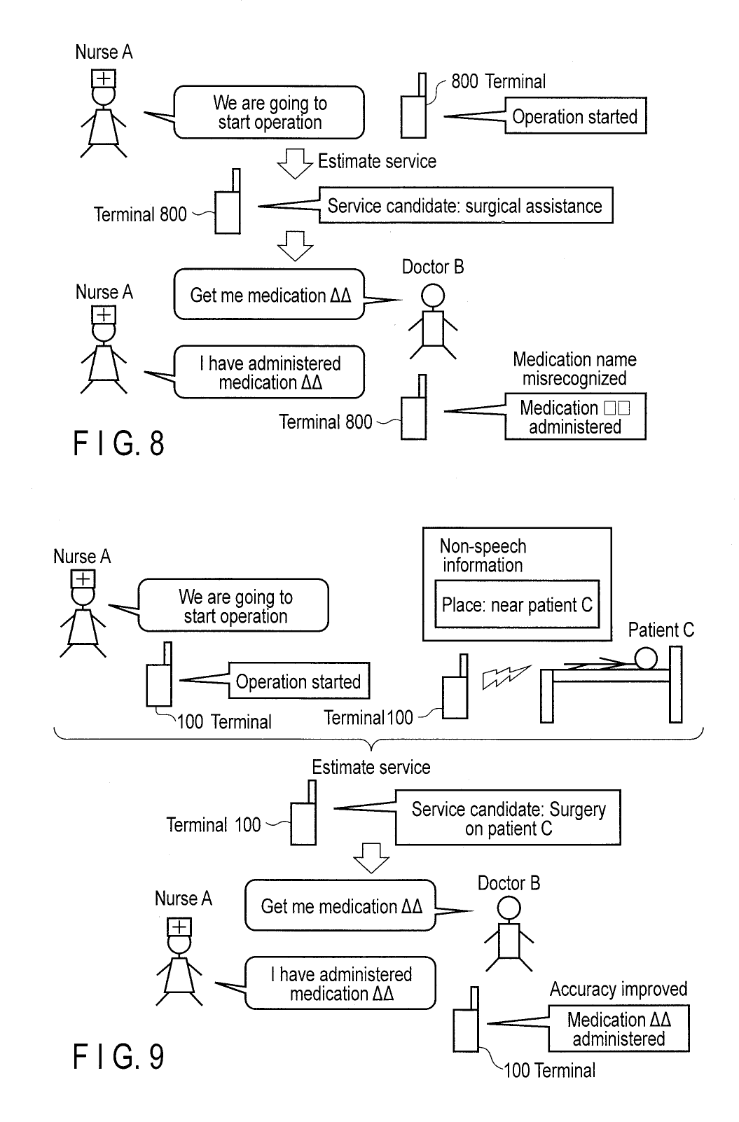

FIG. 8 shows an example of operation of a speech recognition apparatus (terminal) 800 according to Comparative Example 2. In this case, speech recognition apparatus cannot be correctly achieved. As described above, a speech recognition apparatus 800 according to Comparative Example 2 uses only the speech recognition result to estimate the service. First, to record the beginning of a “surgical assistance” service, the nurse A provides speech information to the speech recognition apparatus 800 by saying “We are going to start operation”. Upon receiving the speech information from the nurse A, the speech recognition apparatus 800 determines the service being performed by the nurse to be the “surgical assistance”. That is, the service information includes only the “surgical assistance”. In this state, it is assumed that to record that the nurse A has administered the medication specified by the doctor B to a surgery target patient, the nurse A says “I have administered AA”. In this case, the name of the medication involves a large number of candidates, and thus the speech recognition apparatus 800 is likely to misrecognize the speech information. The name of the medication can be narrowed down by indentifying the surgery target patient, but the narrowing-down cannot be carried out unless the nurse A utters the patient's name.

FIG. 9 shows yet another example of operation of the speech recognition apparatus 100 according to the present embodiment. More specifically, FIG. 9 shows the operation of the speech recognition apparatus 100 in a situation similar to that in the case illustrated in FIG. 8. In this case, the speech recognition apparatus 100 has narrowed down the nurse A's service to the “surgical assistance” by using the speech recognition result. Moreover, as shown in FIG. 9, the speech recognition apparatus 100 acquires tag information from a radio tag, provided to each patient, and narrows down the surgery target patient to the patient C. Since the surgery target patient has been narrowed down to the patient C, the name of the medication is narrowed down to those of medications that can be administered to the patient C. Thus, next time when the nurse A utters the name of a medication, the speech recognition apparatus 100 can correctly recognize the name of the medication uttered by the nurse A.

The speech recognition apparatus 100 is not limited to the example in which the surgery target patient is identified based on such tag information as shown in FIG. 9. The surgery target patient may be identified based on, for example, the nurse A's schedule information.

As described above, the speech recognition apparatus according to the first embodiment can correctly estimate a service being performed by a user by estimating the service being performed by the user, utilizing non-speech information, performing speech recognition in accordance with the speech recognition technique corresponding to service information, and re-estimating the service by using information obtained from the result of the speech recognition. Thus, since the speech recognition can be performed in accordance with the speech recognition technique corresponding to the service being performed by the user, input speeches can be correctly recognized. That is, the speech recognition accuracy is improved.

### Modification 1 of the First Embodiment

The speech recognition apparatus 100 shown in FIG. 1 performs only one operation of re-estimating the service for one operation of inputting speech information. In contrast, a speech recognition apparatus according to Modification 1 of the first embodiment performs a plurality of operations of re-estimating the service for one operation of inputting speech information.

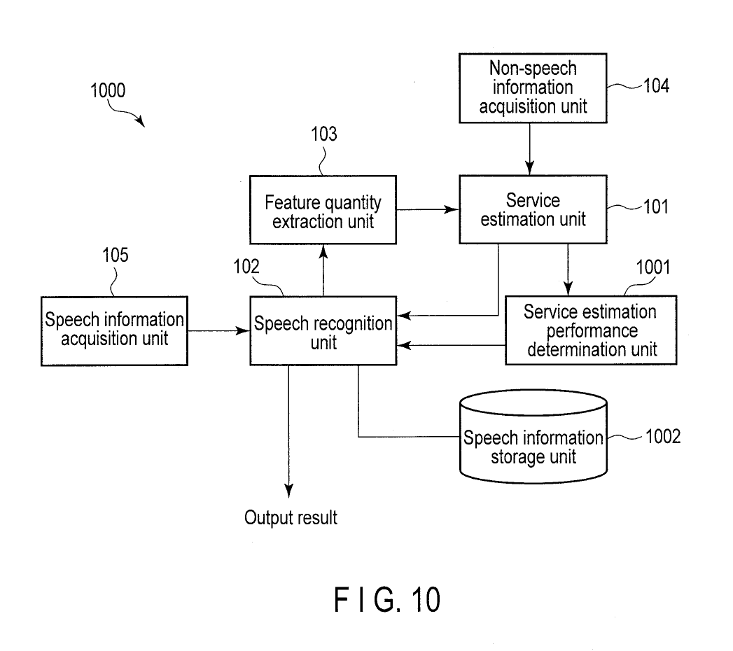

FIG. 10 schematically shows a speech recognition apparatus according to Modification 1 of the first embodiment. The speech recognition apparatus 1000 includes, in addition to the components of the speech recognition apparatus 100 in FIG. 1, a service estimation performance determination unit (hereinafter, referred to simply as a performance determination unit) 1001 and a speech recognition information storage unit 1002. The performance determination unit 1001 determines whether or not to perform estimation of the service. The speech information storage unit 1002 stores input speech information.

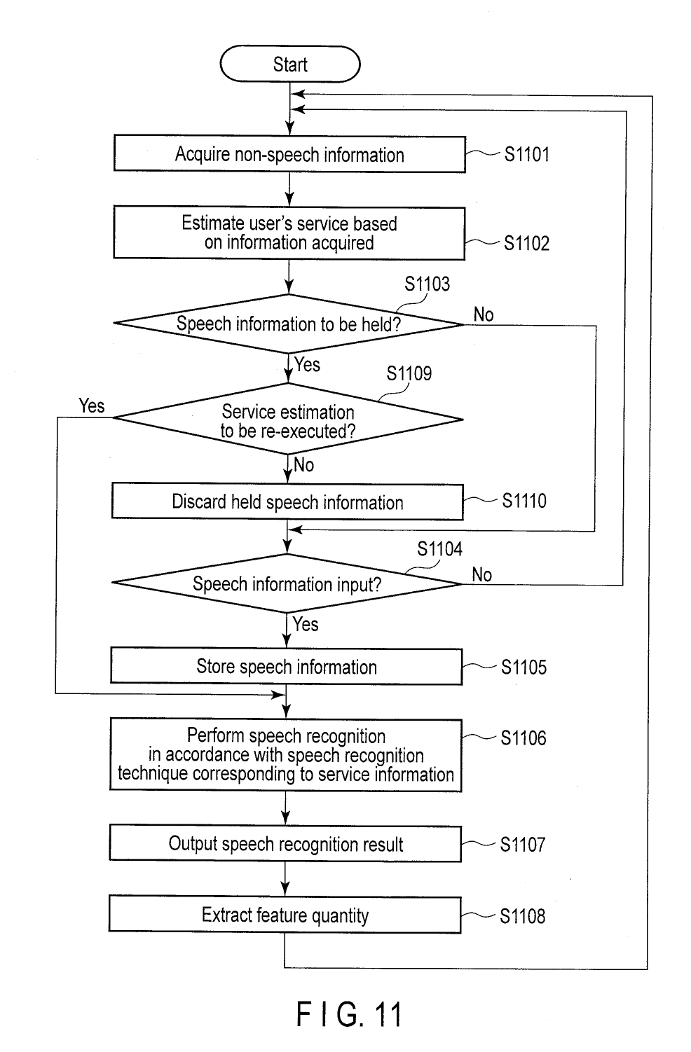

Now, with reference to FIG. 10 and FIG. 11, the operation of the speech recognition apparatus 1000 will be described.

FIG. 11 shows an example of a speech recognition process that is carried out by the speech recognition apparatus 1000. Processing in steps S1101, S1102, S1104, S1106, S1107, and S1108 in FIG. 11 is similar to that in steps S401, S402, S403, S404, S405, and S406 in FIG. 4, respectively. Thus, the description of these steps is omitted as needed.

When the user starts the speech recognition apparatus 1000, the non-speech information acquisition unit 104 acquires non-speech information (step S1101). The service estimation unit 101 estimates the service being currently performed by the user based on the non-speech information (step S1102). Then, the apparatus determines whether or not speech information is stored in the speech information storage unit 1002 (step S1103). If no speech information is held in the speech information storage unit 1002, the process proceeds to step S1104.

The speech recognition unit 102 waits for speech information to be input (step S1104). If no speech information is input, the process returns to step S1101. When the speech recognition unit 102 receives speech information, the process proceeds to step S1105. To provide for a plurality of speech recognition operations to be performed on the received speech information, the speech recognition unit 102 stores the speech information in the speech information storage unit 1002 (step S1105). The processing in step S1105 may follow the processing in step S1106.

Then, the speech recognition unit 102 performs speech recognition on the received speech information in accordance with the speech recognition technique corresponding to the service information (step S1106). The speech recognition unit 102 then outputs the result of the speech recognition (step S1107). The feature quantity extraction unit 103 extracts a feature quantity related to the service being performed by the user, from the speech recognition result (step S1108).

When the feature quantity is detected, the process returns to step S1101.

In step S1102 following the extraction of the feature quantity in step S1108, the service estimation unit 101 re-estimates the service being performed by the user based on the non-speech information and the feature quantity. Subsequently, the apparatus determines whether or not any speech information is stored in the speech information storage unit 1002 (step S1103). If any speech information is stored in the speech information storage unit 1002, the process proceeds to step S1109. The performance determination unit 1001 determines whether or not to re-estimate the service (step S1109). A criterion for determining whether or not to re-estimate the service may be, for example, the number of re-estimation operations performed on the speech information held in the speech information acquisition unit 106, whether the last service information obtained is the same as the current service information obtained, and the degree of a change in service information such as whether the degree of the change between the last service information obtained and the current service information obtained is only comparable to the result of a detailed narrowing-down operation.

If the performance determination unit 1001 determines to estimate the service, the process proceeds to step S1106. In step S1106, the speech recognition unit 102 performs speech recognition on the speech information held in the speech information storage unit 1002. Step S1107 and the subsequent steps are as described above.

In step S1103, if the performance determination unit 1001 determines not to estimate the service, the process proceeds to step S1110. In step S1110, the speech recognition unit 102 discards the speech information held in the speech information storage unit 1002. Thereafter, in step S1104, the speech recognition unit 102 waits for speech information to be input.

As described above, the speech recognition apparatus 1000 performs a plurality of operations of estimating the service for one operation of inputting speech information. This enables the user's service to be estimated in detail with one operation of inputting speech information.

Now, an example of operation of the speech recognition apparatus 1000 according to Modification 1 of the first embodiment will be described in brief.

It is assumed that the speech recognition apparatus 1000 has narrowed down the user's service to three services, the “vital sign check”, the “patient care”, and the “tray service” based on non-speech information as in the example illustrated in FIG. 7 and that at this time, speech information related to the “medication change” is input to the speech recognition apparatus 1000. The speech recognition apparatus 1000 performs speech recognition on the input speech information, extracts a feature quantity from the result of the speech recognition, and re-estimates the service being performed by the user, by using the extracted feature quantity. The re-estimation allows the user's service to be expanded to a range of services that can be being performed by the user. For example, the service information includes the “vital sign check”, the “patient care”, the “tray service”, and the “medication change”. Moreover, the speech recognition apparatus 1000 performs speech recognition on the stored speech information related to the “medication change”, extracts a feature quantity from the result of the speech recognition, and re-estimates the service being performed by the user, by using the extracted feature quantity. As a result, the service being performed by the user is estimated to the “medication change”. Thereafter, when the user inputs speech information related to the “medication change”, the speech recognition apparatus 1000 can correctly recognize the input speech information.

As described above, the speech recognition apparatus according to Modification 1 of the first embodiment performs a plurality of operations of re-estimating the service by using one operation of inputting speech operation. Thus, the user's service can be estimated in detail by performing one operation of inputting speech information.

### Modification 2 of the First Embodiment

The speech recognition apparatus 100 shown in FIG. 1 initially performs speech recognition on input speech information in accordance with the speech recognition technique corresponding to service information generated based on non-speech information. However, if the service being performed by the user is estimated by using non-speech information but not the result of speech recognition and speech recognition is performed in accordance with the speech recognition technique corresponding to service information resulting from the estimation as in the case illustrated in FIG. 6, then the input speech information may be misrecognized. A speech recognition apparatus according to Modification 2 of the first embodiment determines whether or not the speech recognition has been correctly performed, and outputs the result of speech recognition upon determining that the speech recognition has been correctly performed.

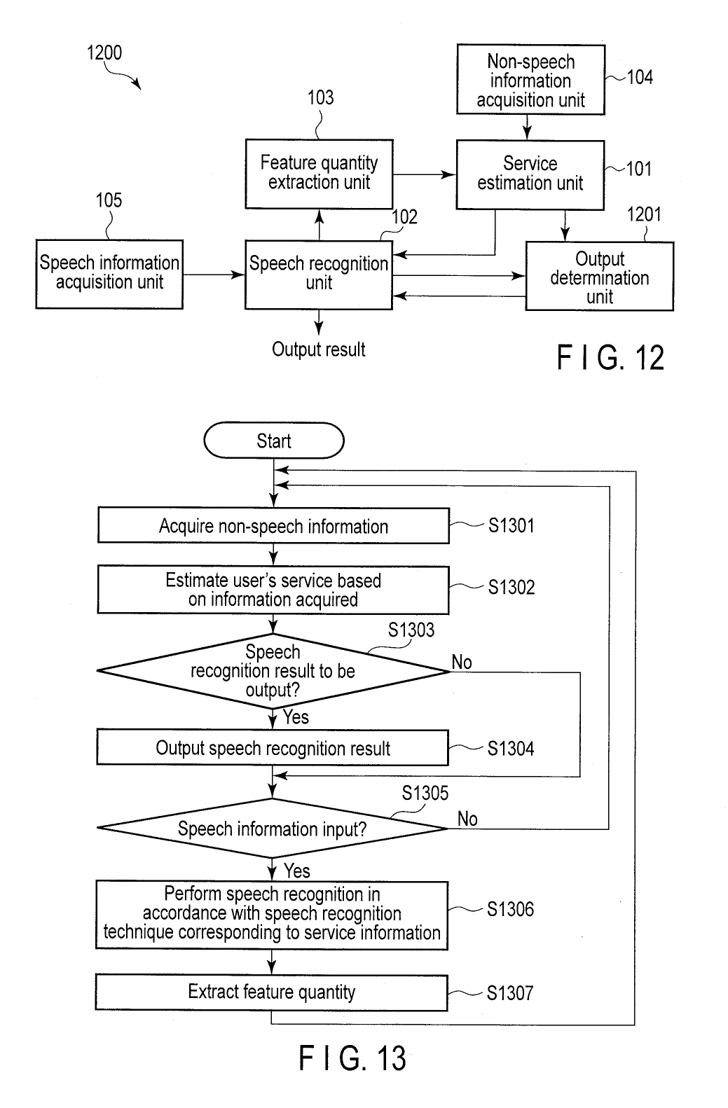

FIG. 12 schematically shows a speech recognition apparatus according to Modification 2 of the first embodiment. The speech recognition apparatus 1200 shown in FIG. 12 comprises an output determination unit 1201 in addition to the components of the speech recognition apparatus 100 shown in FIG. 1. The output determination unit 1201 determines whether or not to output the result of speech recognition based on service information and the speech recognition result. A criterion for determining whether or not to output the speech recognition result may be, for example, the number of re-estimation operations performed for one operation of inputting speech information, whether there is a change between the last service information obtained and the current service information obtained, the degree of a change in service information such as whether the degree of the change is only comparable to the result of a detailed narrowing-down operation, or whether the confidence score of the speech recognition result is equal to or higher than a threshold.

Now, the operation of the speech recognition apparatus 1200 will be described with reference to FIG. 12 and FIG. 13.

FIG. 13 shows an example of a speech recognition process that is executed by the speech recognition apparatus 1200. Processing in steps S1301, S1302, S1304, S1305, S1306, and S1307 in FIG. 13 is the same as that in steps S401, S402, S403, S404, S405, and S406 in FIG. 4, respectively. Thus, the description of these steps is omitted as needed.

First, when the user starts the speech recognition apparatus 1200, the non-speech information acquisition unit 104 acquires non-speech information (step S1301). The service estimation unit 101 estimates the service being currently performed by the user based on the non-speech information, to generate service information (step S1302). Step S1303 and step S1304 are not carried out until speech information is input.

Then, the speech recognition unit 102 waits for speech information to be input (step S1305). Upon receiving speech information, the speech recognition unit 102 performs speech recognition on the received speech information in accordance with the speech recognition technique corresponding to service information (step S1306). Subsequently, the feature quantity extraction unit 103 extracts a feature quantity related to the service being performed by the user, from the speech recognition result (step S1307). When the feature quantity is detected in step S1307, the process returns to step S1301.

In step S1302 following the execution of the speech recognition, the service estimation unit 101 re-estimates the service being performed by the user based on the non-speech information obtained in step S1301 and the feature quantity obtained in step S1307, and newly generates service information. Then, based on the new service information and the speech recognition result, the output determination unit 1201 determines whether or not to output the speech recognition result (step S1303). If the output determination unit 1201 determines to output the speech recognition result, the speech recognition unit 102 outputs the speech recognition result (step S1304).

On the other hand, in step S1303, if the output determination unit 1201 determines not to output the speech recognition result, the speech recognition unit 102 waits for speech information to be input instead of outputting the speech recognition result.

The set of step S1303 and step S1304 may be carried out at any timing after step S1302 and before step S1306. Furthermore, the output determination unit 1201 may determine whether or not to output the speech recognition result, without using the service information. For example, the output determination unit 1201 may determine whether or not to output the speech recognition result, according to the confidence score of the speech recognition result. Specifically, the output determination unit 1201 determines to output the speech recognition result when the confidence score of the speech recognition result is higher than a threshold, and determines not to output the speech recognition result when the confidence score of the speech recognition result is equal to or lower than the threshold. When the service information is not used, the set of step S1303 and step S1304 may be carried out immediately after the execution of the speech recognition in step S1306 or at any timing before step S1306 is executed next time.

As described above, the speech recognition apparatus 1200 determines whether or not to output the result of speech recognition based on the speech recognition result or a set of service information and the speech recognition result. If the input speech information is likely to have been misrecognized, the speech recognition apparatus 1200 re-estimates the service by using the speech recognition result without outputting the speech recognition result.

Now, an example of operation of the speech recognition apparatus 1200 will be described in brief.

The example will be described with reference to FIG. 7 again. The service being performed by the nurse A has been narrowed down to the “vital sign check”, the “patient care”, and the “tray service”. At this time, if the nurse A inputs speech related to the “medication change” service, the speech may fail to be correctly recognized as in the case illustrated in FIG. 6 because the service information does not include the “medication change”. The speech recognition apparatus 1200 determines that the input speech information may have been misrecognized, and outputs no speech recognition result. Thereafter, the speech recognition apparatus 1200 re-estimates the service, and the “medication change” service is added to the service information. With the “medication change” service included in the service information, when speech information related to the “medication change” service is input to the speech recognition apparatus 1200, the speech recognition apparatus 1200 determines that a correct speech recognition result has been obtained, and outputs the speech recognition result. Thus, an accurate speech recognition result can be output without the need for the nurse to make the same speech again.

As described above, the speech recognition apparatus according to Modification 2 of the first embodiment determines whether or not to output the speech recognition result, based at least on the speech recognition result. Thus, the speech recognition result can be output when the input speech information is correctly recognized.

### Modification 3 of the First Embodiment

The speech recognition apparatus 100 shown in FIG. 1 transmits the feature quantity obtained by the feature quantity extraction unit 103 to the service estimation unit 101 to urge the service estimation unit 101 to re-estimate the service. A speech recognition apparatus according to Modification 3 of the first embodiment determines whether or not the service needs to be re-estimated, based on the feature quantity obtained by the feature quantity extraction unit 103, and re-estimates the service upon determining that the service needs to be re-estimated.

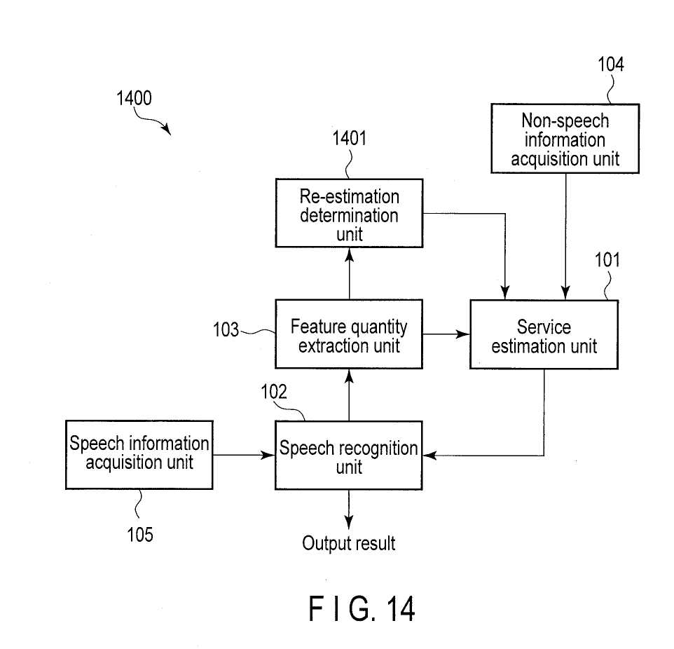

FIG. 14 schematically shows a speech recognition apparatus 1400 according to Modification 3 of the first embodiment. The speech recognition apparatus 1400 includes a re-estimation determination unit 1401 in addition to the components of the speech recognition apparatus 100 shown in FIG. 1. The re-estimation determination unit 1401 determines whether or not to re-estimate the service based on a feature quantity to be used to re-estimate the service.

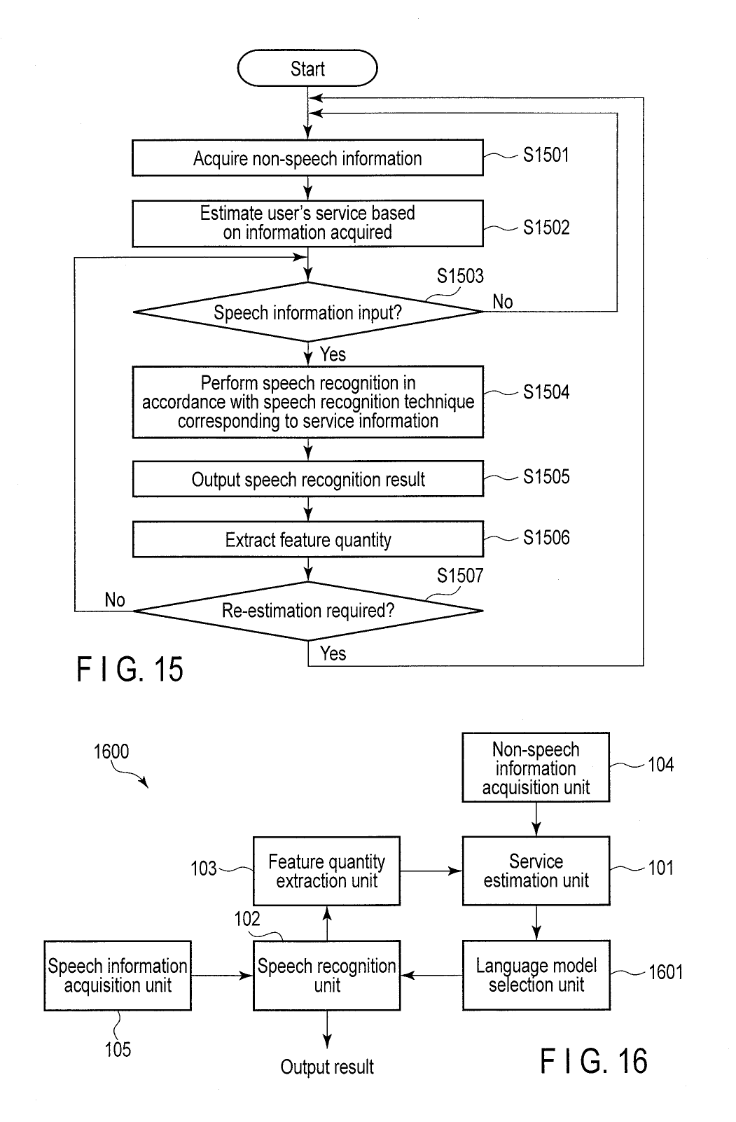

Now, the operation of the speech recognition apparatus 1400 will be described with reference to FIG. 14 and FIG. 15.

FIG. 15 shows an example of a speech recognition process that is executed by the speech recognition apparatus 1400. Processing in steps S1501 to S1506 in FIG. 15 is the same as that in steps S401 to S406 in FIG. 4, respectively. Thus, the description of these steps is omitted as needed.

In step S1506, the feature quantity extraction unit 103 extracts a feature quantity to be used to re-estimate the service, from the result of speech recognition obtained in step S1504. In step S1507, the re-estimation determination unit 1401 determines whether or not to re-estimate the service based on the feature quantity obtained in step S1506. A method for the determination is, for example, to calculate the probability of incorrect service information by using a probability model and schedule information and then to re-estimate the service if the probability is equal to or higher than a predetermined value, as in the case of the method in which the service estimation unit 101 estimates the service by using non-speech information. If the re-estimation determination unit 1401 determines to re-estimate the service, the process returns to step S1501, where the service estimation unit 101 re-estimates the service based on the non-speech information and the feature quantity.

If the re-estimation determination unit 1401 determines not to re-estimate the service, the process returns to step S1503. That is, with the service re-estimation avoided, speech recognition unit 102 waits for speech information to be input.

In the above description, the service re-estimation is avoided if the re-estimation determination unit 1401 determines that the service estimation is unnecessary. However, the service estimation unit 101 may estimate the service based on the non-speech information acquired by the non-speech information acquisition unit 104, without using the feature quantity obtained by the feature quantity extraction unit 103.

As described above, the speech recognition apparatus 1404 determines whether or not re-estimation is required based on the feature quantity obtained by the feature quantity extraction unit 103, and avoids estimating the service if the re-estimation is unnecessary. Thus, unwanted processing can be omitted.

### Second Embodiment

In a second embodiment, a case where the services can be described in terms of a hierarchical structure will be described.

FIG. 16 schematically shows a speech recognition apparatus 1600 according to the second embodiment. The speech recognition apparatus 1600 shown in FIG. 16 includes a language model selection unit 1601 in addition to the components of the speech recognition apparatus 100 shown in FIG. 1. The language model selection unit 1601 selects one of a plurality of prepared language models in accordance with service information received from the service estimation unit 101. In the present embodiment, the speech recognition unit 102 performs speech recognition using the language model selected by the language model selection unit 1601.

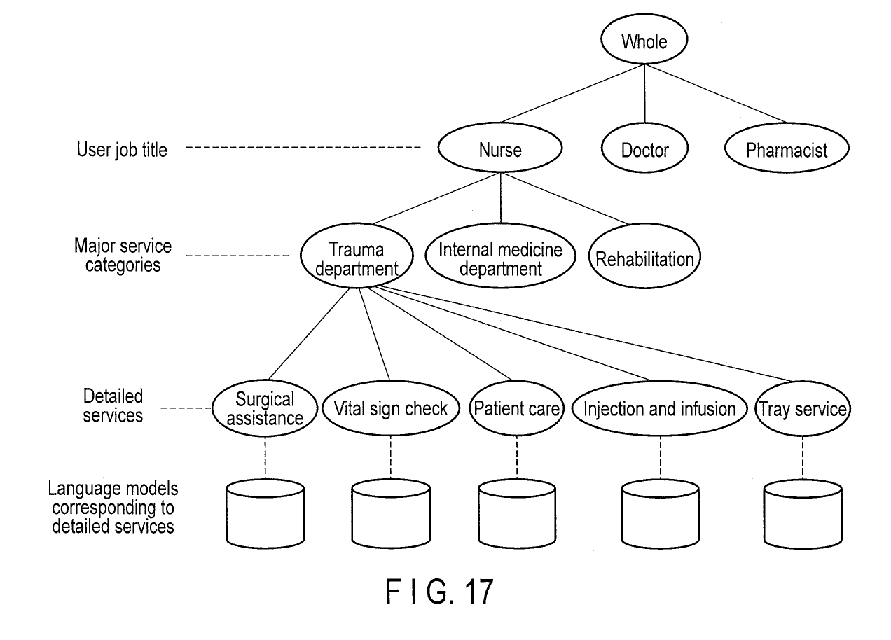

In the present embodiment, as shown in FIG. 17, services that are performed by a user are hierarchized according to the level of detail. A hierarchical structure shown in FIG. 17 includes layers for job titles, major service categories, and detailed services. The job titles include a “nurse”, a “doctor”, and a “pharmacist”. The major service categories include a “trauma department”, an “internal medicine department”, and a “rehabilitation department”. The detailed services include a “surgical assistance (or surgery)”, a “vital sign check”, a “patient care”, an “injection and infusion”, and “tray service”. Language models are associated with the respective services included in the lowermost layer (or terminal) for detailed services. If the estimated service is one of the detailed services, the language model selection unit 1601 selects the language model corresponding to the service indicated by the service information. For example, if the service selected by the service estimation unit 101 is the “surgical assistance”, the language model associated with the “surgical assistance” is selected.

Furthermore, if the estimated service is included in the major service categories, the language model selection unit 1601 selects a plurality of language modes associated with a plurality of services that can be traced from the estimated service. For example, if the estimation result is the “trauma department”, the language models associated with the “surgical assistance”, “vital sign check”, “patient care”, “injection and infusion”, and “tray service” branching from the trauma department are selected. The language model selection unit 1601 combines the selected plurality of language models together to generate a language model to be utilized for speech recognition. An available method for combining the language models together is the averaging, for all the selected language models, of the appearance probability of each of the words contained in each of the language models, the adoption of the speech recognition result from the language model which has a highest confidence score, or any other existing method.

On the other hand, if the service information includes a plurality of services, the language model selection unit 1601 selects and combines a plurality of language models corresponding to the respective services to generate a language model. The language model selection unit 1601 transmits the selected or generated language model to the speech recognition unit 102.

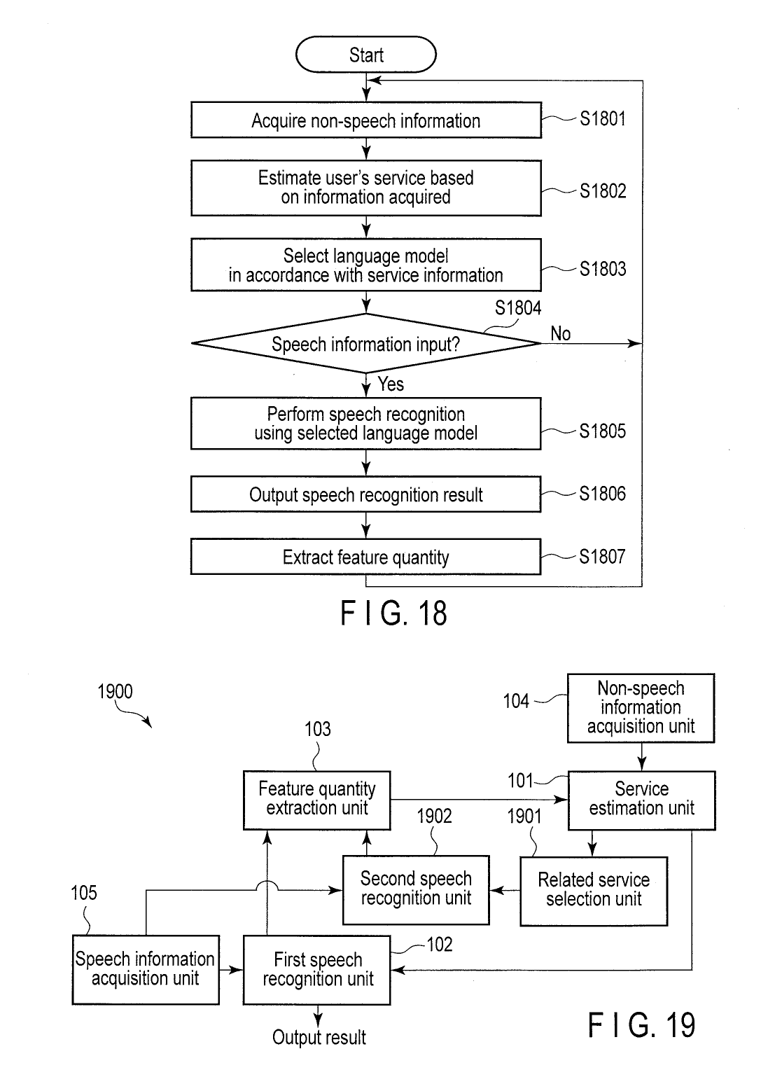

Now, the operation of the speech recognition apparatus 1600 will be described with reference to FIG. 16 and FIG. 18.

FIG. 16 shows an example of a speech recognition process that is executed by the speech recognition apparatus 1600. Processing in steps S1801, S1802, S1804, S1806, and S1807 in FIG. 18 is the same as that In steps S401, S402, S403, S405, and S406 in FIG. 4, respectively. Thus, the description of these steps is omitted as needed.

First, when the user starts the speech recognition apparatus 100, the non-speech information acquisition unit 104 acquires non-speech information (step S1801). The service estimation unit 101 estimates the service being currently performed by the user based on the non-speech information (step S1802). Then, the language model selection unit 1601 selects a language model in accordance with service information from the service estimation unit 101 (step S1803).

Once the language model is selected, the speech recognition unit 102 waits for speech information to be input (step S1804). When the speech recognition unit 102 receives speech information, the process proceeds to step S1805. The speech recognition unit 102 performs speech recognition on the speech information using the language model selected by the language model selection unit 1601 (step S1805).

In step S1804, if no speech information is input, the process returns to step S1801. That is, steps S1801 to S1804 are repeated until speech information is input. Once the language model is selected, speech information may be input at any timing between step S1805 and step S1804. That is, the selection of the language model in step S1803 may precede the speech recognition in step S1805.

When the speech recognition in step S1805 ends, the speech recognition unit 102 outputs the result of the speech recognition (step S1806). Moreover, the feature quantity extraction unit 103 extracts a feature quantity to be used to re-estimate the service, from the speech recognition result (step S1807). When the feature quantity is extracted, the process returns to step S1801.

Thus, the speech recognition apparatus 1600 estimates the service based on non-speech information, selects a language model in accordance with service information, performs speech recognition using the selected language model, and uses the result of the speech recognition to re-estimate the service.

When the service is re-estimated, the range of candidates for the service is limited to services obtained by abstracting the already estimated service and services obtained by embodying the already estimated service. This allows the service to be effectively re-estimated. In an example illustrated in FIG. 17, if the estimated service is the “trauma department”, candidates for the service being performed by the user are “whole”, the “nurse”, the “surgical assistance”, the “vital sign check”, the “patient care”, the “injection and infusion”, and the “tray service”. In this example, the services obtained by abstracting the “trauma department” are the “whole” and the “nurse”. The services obtained by embodying the “trauma department” are the “surgical assistance”, the “vital sign check”, the “patient care”, the “injection and infusion”, and the “tray service”. Furthermore, to limit the candidates for the user's service, a range for limitation may be set by using the level of detail. In the example in FIG. 17, if the estimated service is the “nurse”, when the difference in the level of detail is limited to one level, the candidates for the user's service are the “whole” and the “trauma department”.

As described above, the speech recognition apparatus according to the second embodiment can correctly estimate the service being performed by the user by estimating the service based on non-speech information, selecting a language model in accordance with service information, performing speech recognition using the selected language model, and using the result of the speech recognition to re-estimate the service. The speech recognition apparatus according to the second embodiment can perform speech recognition in accordance with the speech recognition technique corresponding to the service being performed by the user. Therefore, the speech recognition accuracy can be improved.

### Third Embodiment

In the first embodiment, a feature quantity to be used to re-estimate the service is extracted from the result of speech recognition performed in accordance with the speech recognition technique corresponding to service information. The service can be more accurately re-estimated by further performing speech recognition in accordance with the speech recognition technique corresponding to a service different from the one indicated by the service information, extracting a feature quantity from the speech recognition result, and re-estimating the service also by using the feature quantity.

FIG. 19 schematically shows a speech recognition apparatus 1900 according to a third embodiment. As shown in FIG. 19, the speech recognition apparatus 1900 includes the service estimation unit 101, the speech recognition unit (also referred to as a first speech recognition unit) 102, the feature quantity extraction unit 103, the non-speech information input unit 104, the speech information acquisition unit 105, a related service selection unit 1901, and a second speech recognition unit 1902. The service estimation unit 101 according to the present embodiment transmits service information to the first speech recognition unit 102 and the related service selection unit 1901.

Based on the service obtained by the service estimation unit 101, the related service selection unit 1901 selects any of a plurality of predetermined services which is utilized to re-estimate the service (this service is hereinafter referred to as a related service). In one example, the related service selection unit 1901 selects any of the services which is different from the one indicated by the service information, as the related service. The related service selection unit 1901 is not limited to the example in which the related service selection unit 1901 selects the related service based on the service estimated by the service estimation unit 101, but may constantly select the same service as the related service. Moreover, the number of related services selected is not limited to one, but a plurality of services may be selected as the related service. For example, the related service may be a combination of all of a plurality of predetermined services. Alternatively, if absolutely correct non-speech, for example, user information has been acquired, the related service may be services identified based on the non-speech information or to which the service being performed by the user is narrowed down. Furthermore, if the predetermined services are described in terms of a hierarchical structure as in the case of the second embodiment, the related service may be services obtained by abstracting the service estimated by the service estimation unit 101. Related service information indicative of the related service is transmitted to the second speech recognition unit 1902.

The second speech recognition unit 1902 performs speech recognition in accordance with the speech recognition technique corresponding to the related service information. The second speech recognition unit 1902 can perform speech recognition according to the same method as that used by the first speech recognition unit 102. The result of speech recognition performed by the second speech recognition unit 1902 is transmitted to the feature quantity extraction unit 103.

The feature quantity extraction unit 103 according to the present embodiment extracts a feature quantity related to the service being performed by the user, by using the result of speech recognition performed by the first speech recognition unit 102 and the result of speech recognition performed by the second speech recognition unit 1902. The extracted feature quantity is transmitted to the service estimation unit 101. What feature quantity is extracted will be described below.

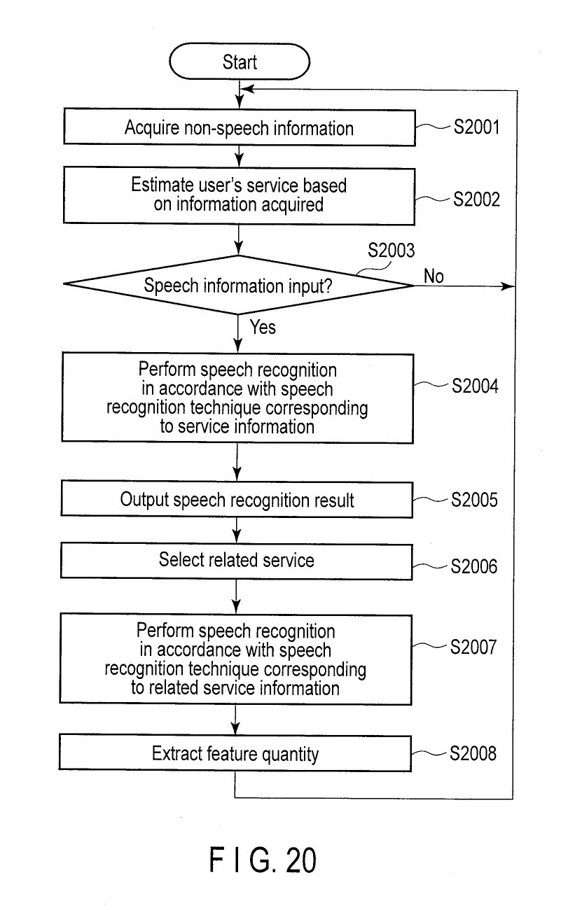

Now, the operation of the speech recognition apparatus 1900 will be described with reference to FIG. 19 and FIG. 20.

FIG. 20 shows an example of a speech recognition process that is executed by the speech recognition apparatus 1900. Processing in steps S2001 to S2005 in FIG. 20 is the same as that in steps S401 to S405 in FIG. 4, respectively. Thus, the description of these steps is omitted as needed.

In step S2006, based on service information generated by the service estimation unit 101, the related service selection unit 1901 selects a related service to be utilized to re-estimate the service and generate related service information indicating the selected related service. In step S2007, the second speech recognition unit 1902 performs speech recognition in accordance with the speech recognition technique corresponding to the related service information. The set of step S2006 and step S2007 and the set of step S2004 and step S2005 may be carried out in the reverse order or at the same time. Furthermore, if the related service is prevented from varying depending on the service information as in the case where the same service constantly remains the related service, the processing in step S2001 may be carried out at any timing.

In one example, the feature quantity extraction unit 103 extracts the language model likelihood of the speech recognition result from the first speech recognition unit 102 and the language model likelihood of the speech recognition result from the second speech recognition unit 1902, as feature quantities. Alternatively, the feature quantity extraction unit 103 may determine the difference between these likelihoods to be a feature quantity. If the language model likelihood of the speech recognition result from the second speech recognition unit 1902 is higher than that of the language portion of the speech recognition result from the first speech recognition unit 102, the service needs to be re-estimated because the language model likelihood of the speech recognition is expected to be increased by speech recognition for a service different from the one indicated by the service information. If the language model likelihood of the speech recognition result from the first speech recognition unit 102 and the language model likelihood of the speech recognition result from the second speech recognition unit 1902 are extracted as feature quantities, the related service may be a combination of all of a plurality of predetermined services or services specified by a particular type of non-speech information such as user information. The above-described feature quantities may be used together for re-estimation as needed.

Moreover, the speech recognition apparatus 1900 can estimate the service in detail by performing speech recognition by using a plurality of language models associated with the respective predetermined services and comparing the likelihoods of a plurality of resultant speech recognition results together. Alternatively, the user's service may be estimated utilizing any other method described in another document.

As described above, the speech recognition apparatus according to the third embodiment can estimate the service more accurately than that according to the first embodiment, by using the information (i.e., feature quantity) obtained from the result of the speech recognition performed in accordance with the speech recognition technique corresponding to the service information and the result of the speech recognition performed in accordance with the speech recognition technique corresponding to the related service information, to re-estimate the service. Thus, the speech recognition can be performed according to the service being performed by the user, improving the speech recognition accuracy.

### Fourth Embodiment

In the first embodiment, a feature quantity related to the service being performed by the user is extracted from the result of speech recognition. In contrast, in a fourth embodiment, a feature quantity related to the service being performed by the user is further extracted from the result of phoneme recognition. Then, the service can be more accurately estimated by using the feature quantity obtained from the speech recognition result and the feature quantity obtained from the phoneme recognition result.

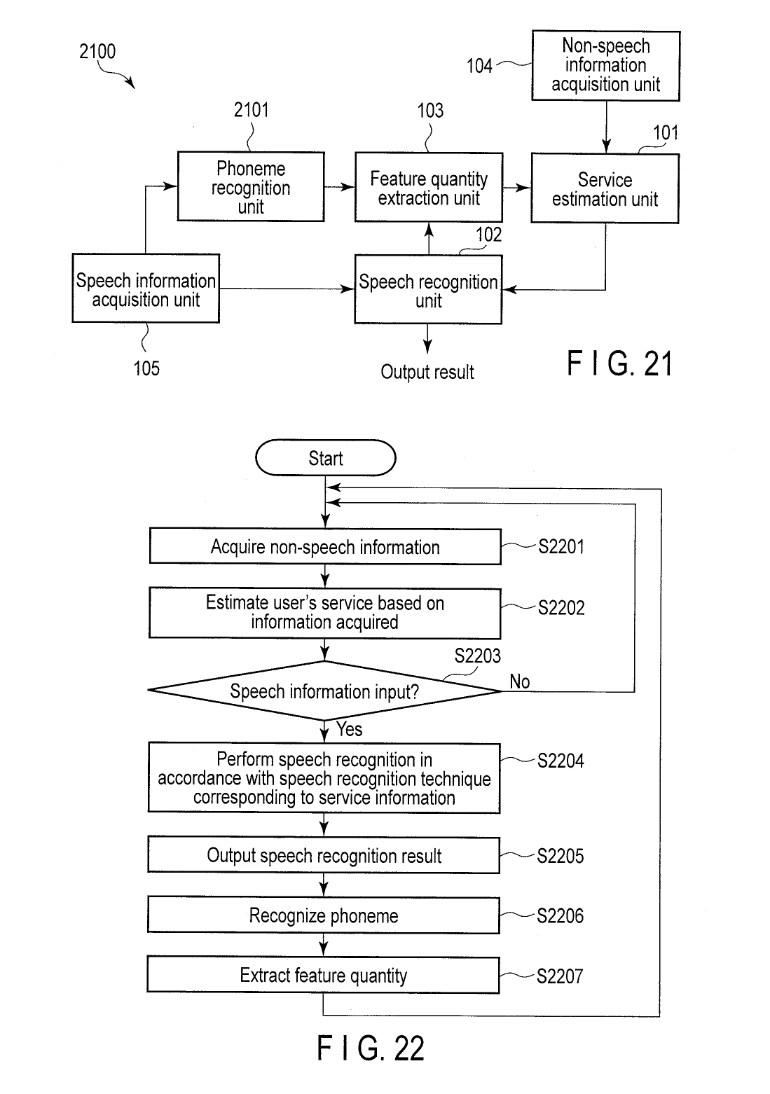

FIG. 21 schematically shows a speech recognition apparatus 2100 according to the fourth embodiment. The speech recognition apparatus 2100 includes the service estimation unit 101, the speech recognition unit 102, the feature quantity extraction unit 103, the non-speech information acquisition unit 104, the speech information acquisition unit 105, and a phoneme recognition unit 2101. The phoneme recognition unit 2101 performs phoneme recognition on input speech information. The phoneme recognition unit 2101 transmits the result of the phoneme recognition to the feature quantity extraction unit 103. The feature quantity extraction unit 103 according to the present embodiment extracts feature quantities from the speech recognition result obtained by the speech recognition unit 102 and the phoneme recognition result obtained by the phoneme recognition unit 2101. The feature quantity extraction unit 103 transmits the extracted feature quantities to the service estimation unit 101. What feature quantities are extracted will be described below.

Now, the operation of the speech recognition apparatus 2100 will be described with reference to FIG. 21 and FIG. 22.

FIG. 22 shows an example of a speech recognition process that is executed by the speech recognition apparatus 2100. Processing in steps S2201 to S2205 in FIG. 22 is the same as that in steps S401 to S405 in FIG. 4, respectively. Thus, the description of these steps is omitted as needed.

In step S2206, the phoneme recognition unit 2101 performs phoneme recognition on input speech information. Step S2206 and the set of steps S2204 and S2205 may be carried out in the reverse order or at the same time.

In step S2207, the feature quantity extraction unit 103 extracts feature quantities to be used to re-estimate the service, from the speech recognition result received from the speech recognition unit 102 and from the phoneme recognition result received from the phoneme recognition unit 2101. In one example, the feature quantity extraction unit 103 extracts the likelihood of the phoneme recognition result and the acoustic model likelihood of the speech recognition result as feature quantities. The acoustic model likelihood of the speech recognition result is indicative of the acoustic probability of the speech recognition result. More specifically, the acoustic model likelihood of the speech recognition result indicates the likelihood resulting from an acoustic model, which is included in the likelihoods of the speech recognition result obtained by probability calculations for the speech recognition result from an acoustic model. In another example, the feature quantity may be the difference between the likelihood of the phoneme recognition result and the acoustic model likelihood of the speech recognition result. If the difference between the likelihood of the phoneme recognition result and the acoustic model likelihood of the speech recognition result is small, the user's speech is expected to be similar to a string of words that can be expressed by the language model, that is, the user's service is expected to have been correctly estimated. Thus, the feature quantities allow unnecessary re-estimation of a service to be avoided.

As described above, the speech recognition apparatus according to the fourth embodiment can more accurately estimate the service being performed by the user by re-estimating the service by using the result of speech recognition and the result of phoneme recognition. This allows speech recognition to be achieved according to the service being performed by the user, thus improving the speech recognition accuracy.

### Fifth Embodiment

In the first embodiment, a feature quantity related to the service being performed by the user is extracted from the result of speech recognition. In contrast, in the fifth embodiment, a feature quantity related to the service being performed by the user is extracted from the result of speech recognition and also from input speech information proper. The use of these feature quantities enables the service to be more accurately estimated.

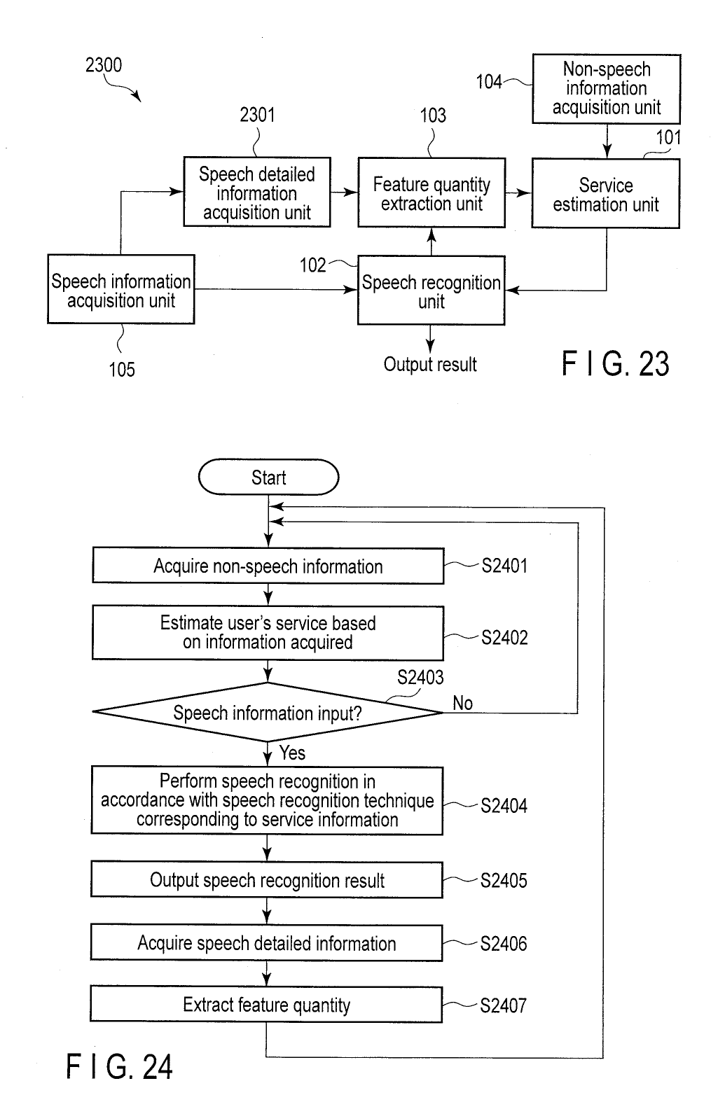

FIG. 23 schematically shows a speech recognition apparatus 2300 according to the fifth embodiment. The speech recognition apparatus 2300 shown in FIG. 23 includes a speech detailed information acquisition unit 2301 in addition to the components of the speech recognition apparatus 100 shown in FIG. 1.

The speech detailed information acquisition unit 2301 acquires speech detailed information from speech information and transmits the information to the feature quantity extraction unit 103. Examples of the speech detailed information include the length of speech, the volume or waveform of speech at each point of time, and the like.

The feature quantity extraction unit 103 according to the present embodiment extracts a feature quantity to be used to re-estimate the service, from the speech recognition received from the speech recognition unit 102 and from the speech detailed information received from the speech detailed information acquisition unit 2301.

Now, the operation of the speech recognition apparatus 2300 will be described with reference to FIG. 23 and FIG. 24.

FIG. 24 shows an example of a speech recognition process that is executed by the speech recognition apparatus 2300. Processing in steps S2401 to S2405 in FIG. 24 is the same as that in steps S401 to S405 in FIG. 4, respectively. Thus, the description of these steps is omitted as needed.

In step S2406, the speech detailed information acquisition unit 2301 extracts speech detailed information available for re-estimation of the service, from the input speech information. Step S2406 and the set of step S2404 and step S2405 may be carried out in the reverse order or at the same time.

In step S2407, the feature quantity extraction unit 103 extracts feature quantities related to the service being performed by the user, from the result of speech recognition performed by the speech recognition unit 102 and also from the speech detailed information obtained by the speech detailed information acquisition unit 2301.

The feature quantity extracted from the speech detailed information is, for example, the length of the input speech information, and the level of ambient noise contained in the speech information. If the speech information is extremely small in length, the speech information is likely to have been inadvertently input by, for example, mistaken operation of the terminal. The use of the length of speech information as a feature quantity allows prevention of the re-estimation of the service based on mistakenly input speech information. Furthermore, loud ambient noise may make the speech recognition result erroneous even though the user's service is correctly estimated. Thus, if the level of the ambient noise is high, the re-estimation of the service is avoided. Hence, the use of the level of the ambient noise allows prevention of the re-estimation of the service using a possibly erroneous speech recognition result. A possible method for detecting the level of the ambient noise is to assume that an initial portion of the speech information contains none of the user's speech and to define the level of the ambient noise as the level of the sound in the initial portion.

As described above, the speech recognition apparatus according to the fourth embodiment can more accurately re-estimate the service by using the information included in the input speech information proper to re-estimate the service. This allows speech recognition to be achieved according to the service being performed by the user, thus improving the speech recognition accuracy.

The instructions involved in the process procedures disclosed in the above-described embodiments can be executed based on a program that is software. Effects similar to those of the speech recognition apparatuses according to the above-described embodiments can also be exerted by storing the program in a general-purpose computer system and allowing the computer system to read in the program. The instructions described in the above-described embodiments are recorded in a magnetic disk (flexible disk, hard disk, or the like), an optical disc (CD-ROM, CD−R, CD−RW, DVD-ROM, DVD±R, DVD±RW, or the like), a semiconductor memory, or a similar recording medium. The above-described recording media may have any storage format provided that a computer or an embedded system can read data from the recording media. The computer can implement operations similar to those of the wireless communication device according to the above-described embodiments by reading the program from the recording medium and allowing CPU to carry out the instructions described in the program, based on the program. Of course, the computer may acquire or read the program through a network.

Furthermore, the processing required to implement the embodiments may be partly carried out by OS (Operating System) operating on the computer based on the instructions in the program installed from the recording medium into the computer or embedded system, or MW (Middle Ware) such as database management software or network software.

Moreover, the recording medium according to the present embodiments is not limited to a medium independent of the computer or the embedded system but may be a recording medium in which the program transmitted via LAN, the Internet, or the like is downloaded and recorded or temporarily recorded.

Additionally, the embodiments are not limited to the use of a single medium, but the processing according to the present embodiments may be executed from a plurality of media. The medium may have any configuration.

In addition, the computer or embedded system according to the present embodiments executes the processing according to the present embodiments based on the program stored in the recording medium. The computer or embedded system according to the present embodiments may be optionally configured and may thus be an apparatus formed of one personal computer or microcomputer or a system with a plurality of apparatuses connected together via a network.

Furthermore, the computer according to the present embodiments is not limited to the personal computer but may be an arithmetic processing device, a microcomputer, or the like which is contained in an information processing apparatus. The computer according to the present embodiments is a generic term indicative of apparatuses and devices capable of implementing the functions according to the present embodiments based on the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech recognition apparatus comprising:
a service estimation unit configured to estimate a service being performed by a user, by using non-speech information related to a user's service, and to generate service information indicating a content of the estimated service;
a first speech recognition unit configured to perform speech recognition on speech information provided by the user, in accordance with a speech recognition technique corresponding to the service information, and to generate a first speech recognition result; and
a feature quantity extraction unit configured to extract at least one feature quantity related to the service being performed by the user, from the first speech recognition result,
wherein the service estimation unit re-estimates the service by using the at least one feature quantity, and the first speech recognition unit performs speech recognition based on service information resulting from the re-estimation.

2. The apparatus according to claim 1, wherein the feature quantity extraction unit extracts, as the at least one feature quantity, at least one of an appearance frequency of each word contained in the first speech recognition result, a language model likelihood of the first speech recognition result, and a number of times or a rate of presence of a sequence of words absent from learning data used to create a language model for use in the first speech recognition unit.

3. The apparatus according to claim 1, further comprising a language model selection unit configured to select a language model from a plurality of predetermined language models, in accordance with the service information,
wherein the first speech recognition unit performs speech recognition using the selected language model.

4. The apparatus according to claim 3, wherein a plurality of predetermined services are described in terms of a hierarchical structure, and the language models are associated with services positioned at a terminal of the hierarchical structure, and
the language model selection unit selects a language model corresponding to the estimated service indicated by the service information.

5. The apparatus according to claim 1, further comprising:
a related service selection unit configured to select a related service to be utilized to re-estimate the service, from a plurality of predetermined services, and to generate related service information indicating the selected related service; and
a second speech recognition unit configured to perform speech recognition on the speech information in accordance with the speech recognition technique corresponding to the related service information, and to generate a second speech recognition result,
wherein the feature quantity extraction unit extracts the at least one feature quantity from the first speech recognition result and the second speech recognition result.

6. The apparatus according to claim 5, wherein the related service selection unit selects, as the related service, one of a combination of all of the plurality of services and a service specified by the non-speech information, and
the feature quantity extraction unit extracts, as a first feature quantity, a language model likelihood of the first speech recognition result, and extracts, as a second feature quantity, a language model likelihood of the second speech recognition result, the at least one feature quantity including the first feature quantity and the second feature quantity.

7. The apparatus according to claim 1, further comprising a phoneme recognition unit configured to perform phoneme recognition on the speech information and to generate a phoneme recognition result,
wherein the feature quantity extraction unit extracts the at least one feature quantity from the first speech recognition result and the phoneme recognition result.

8. The apparatus according to claim 7, wherein the feature quantity extraction unit extracts, as a first feature quantity, a acoustic model likelihood of the first speech recognition result and extracts, as a second feature quantity, a likelihood of the phoneme recognition result, the at least one feature quantity including the first feature quantity and the second feature quantity.

9. The apparatus according to claim 1, wherein the feature quantity extraction unit extracts the at least one feature quantity from the first speech recognition result and the speech information.

10. The apparatus according to claim 9, wherein the feature quantity extraction unit extracts, as a first feature quantity, at least one of an appearance frequency of each word contained in the first speech recognition result, a language model likelihood of the first speech recognition result, and a number of times or a rate of presence of a sequence of words absent from learning data used to create a language model for use in the first speech recognition unit, and extracts, as a second feature quantity, at least one of at least one of a length of the speech information and a level of ambient noise contained in the speech information, the at least one feature quantity including the first feature quantity and the second feature quantity.

11. A speech recognition method comprising:
estimating a service being performed by a user, by using non-speech information related to a user's service, to generate service information indicating a content of the estimated service;
performing speech recognition on speech information provided by the user, in accordance with a speech recognition technique corresponding to the service information, and generating a first speech recognition result;
extracting at least one feature quantity related to the service being performed by the user, from the first speech recognition result;
re-estimating the service by using the at least one feature quantity; and
performing speech recognition based on service information resulting from the re-estimation.

12. A non-transitory computer readable medium including computer executable instructions, wherein the instructions, when executed by a processor, cause the processor to perform a method comprising:
estimating a service being performed by a user, by using non-speech information related to a user's service, to generate service information indicating a content of the estimated service;
performing speech recognition on speech information provided by the user, in accordance with a speech recognition technique corresponding to the service information, and generating a first speech recognition result;
extracting at least one feature quantity related to the service being performed by the user, from the first speech recognition result;
re-estimating the service by using the at least one feature quantity; and
performing speech recognition based on service information resulting from the re-estimation.
